(19) United States
(12) Patent Application Publication
(10) Pub. No.: US 2017/0207687 A1
(43) Pub. Date: Jul. 20, 2017

(54) End Cap Assembly And Motor Employing Same

(71) Applicant: Johnson Electric S.A., Murten (CH)

(72) Inventors: Qing Bin LUO, Shenzhen (CN); Chi Wai LAI, Hong Kong (CN); Wen Ming WU, Shenzhen (CN); Bo HU, Shenzhen (CN); Xiao Lin REN, Shenzhen (CN)

(21) Appl. No.: 15/407,703

(22) Filed: Jan. 17, 2017

(30) Foreign Application Priority Data
Jan. 14, 2016 (CN) 2016 1002 7315.4

(51) Int. Cl. H02K 11/22; H02K 11/00; H02K 5/22

(52) U.S. Cl. CPC H02K 11/022; H02K 5/225; H02K 11/0094

(57) ABSTRACT

An end cap assembly includes an end cap. The end cap includes an end wall, a sidewall, and a shielding member. The sidewall projects from one side of the end wall. The sidewall defines a cutout for allowing two conducting wires to pass therethrough, and the two conducting wires connect components mounted within the end cap to an external power source. The shielding member is disposed in the cutout. The end cap assembly provides enhanced EMI suppression. In addition, the present invention also provides a motor employing the end cap assembly.

### CROSS REFERENCE TO RELATED APPLICATIONS

This non-provisional patent application claims priority under 35 U.S.C. §119(a) from Patent Application No. 201610027315.4 filed in The People's Republic of China on Jan. 14, 2016.

### FIELD OF THE INVENTION

The present invention relates to motors, and in particular to an end cap assembly and a motor employing the end cap assembly.

### BACKGROUND OF THE INVENTION

Motors have been widely used as a driving device. The motors usually include a stator, a rotor, and an end cap. One of the stator and rotor is provided with exciting coils. In operation of the motor, an external electric current (exciting current) needs to flow through the exciting coils to produce a magnetic field. Electromagnetic interference (EMI) generated during operation of the motor has been hindering the motor development.

The usual method currently used for suppressing electromagnetic interference is providing an electromagnetic interference suppressing circuit in the motor circuit. However, the motor can still cause EMI to surrounding electric components due to the structure design of the end cap assembly of the motor, such as the provision of holes or slots.

### SUMMARY OF THE INVENTION

Thus, there is a desire for an end cap assembly capable of suppressing EMI and a motor employing the end cap assembly.

In one aspect, an end cap assembly is provided which includes an end cap. The end cap includes an end wall, a sidewall, and a shielding member. The sidewall projects from one side of the end wall to bounding a space receiving a plurality electrical components. The sidewall defines a cutout for allowing two conducting wires to pass therethrough, and the two conducting wires connect the electrical components mounted within the end cap to an external power source. The shielding member is disposed in the cutout.

Preferably, the conducting wires pass through the cutout from opposite sides of the shielding member, respectively.

Preferably, a flange extends from an outer edge of the end wall in the same extending direction as the sidewall, and the flange defines an opening aligned with the cutout.

Preferably, one end of the sidewall defines an engagement groove, and the shielding member and the sidewall have the same height.

Preferably, the end cap assembly further includes a mounting bracket, one end of the sidewall defines an engagement groove, and one end of the mounting bracket is engaged in the engagement groove.

Preferably, the engagement groove is annular and has two ends in communication with the cutout.

Preferably, the shielding member is elongated, which is located at a middle of the cutout to divide the cutout into left and right portions.

Preferably, the end cap includes a positioning portion, the mounting bracket defines a latch portion, and the positioning member is latched in the latch portion; or the mounting bracket includes a positioning portion, the end cap defines a latch portion, and the positioning portion is latched in the latch portion.

Preferably, the end cap includes a guide post, the mounting bracket includes an engagement hole, and the guide post is received in the engagement hole; or the mounting bracket includes a guide post, the end cap includes an engagement hole, and the guide post is received in the engagement hole.

In another aspect, a motor is provided which includes a housing, a stator assembly, a rotor assembly, a commutator, and two conducting wires. The motor further includes an end cap assembly in accordance with any embodiment described above. The end cap assembly is mounted at one end of the housing to enclose the stator assembly, the rotor assembly, and the commutator in the housing. The conducting wires pass through the end cap assembly to connect with an external power source.

In this invention, the shielding member is disposed in the cutout, which effectively enhances the EMI shielding performance of the cutout and suppresses the spread of noise of the motor.

### BRIEF DESCRIPTION OF THE DRAWINGS

FIG. 1 is a perspective view of a motor according to a preferred embodiment of the present invention.

FIG. 2 is a partial perspective, exploded view of the motor of FIG. 1.

FIG. 3 is a perspective, exploded view of the end cap assembly of FIG. 1.

FIG. 4 is a perspective, exploded view of the end cap assembly of FIG. 3, viewed from another aspect.

FIG. 5 shows theoretical calculations of the EMI shielding performance of the motor of FIG. 1 and a traditional motor.

FIG. 6 shows EMI simulation results of the motor of FIG. 1 and the traditional motor.

FIG. 7 shows EMI test results of the traditional motor.

FIG. 8 shows EMI test results of the motor of FIG. 1.

### DESCRIPTION OF REFERENCE NUMERALS OF MAIN COMPONENTS

Below, embodiments of the present invention will be described in detail with reference to the accompanying drawings.

### DETAILED DESCRIPTION OF THE PREFERRED EMBODIMENTS

The technical solutions of the embodiments of the present invention will be clearly and completely described as follows with reference to the accompanying drawings. Apparently, the embodiments as described below are merely part of, rather than all, embodiments of the present invention. Based on the embodiments of the present disclosure, any other embodiment obtained by a person skilled in the art without paying any creative effort shall fall within the protection scope of the present invention.

It is noted that, when a component is described to be “fixed” to another component, it can be directly fixed to the another component or there may be an intermediate component. When a component is described to be “connected” to another component, it can be directly connected to the another component or there may be an intermediate component. When a component is described to be “disposed” on another component, it can be directly disposed on the another component or there may be an intermediate component.

Unless otherwise specified, all technical and scientific terms have the ordinary meaning as understood by people skilled in the art. The terms used in this disclosure are illustrative rather than limiting.

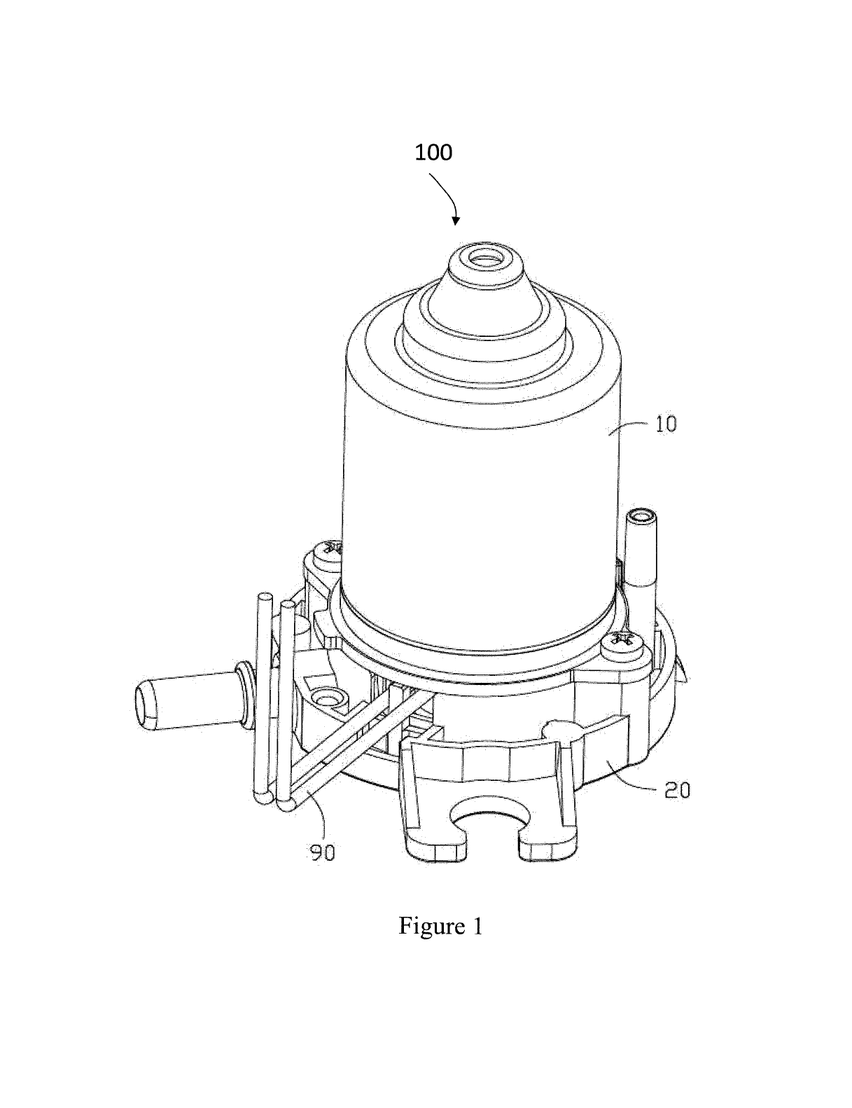

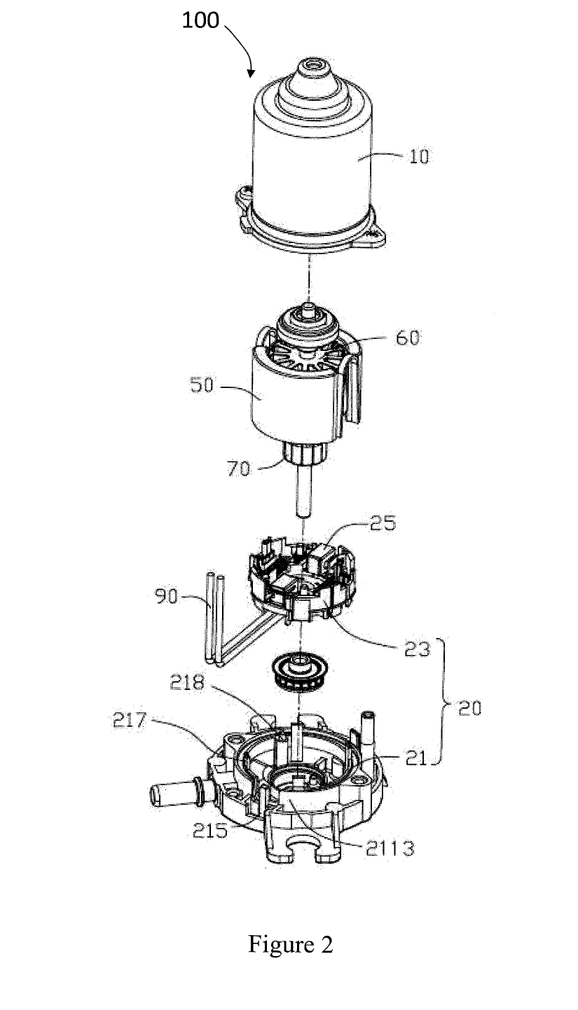

Referring to FIG. 1 and FIG. 2, a preferred embodiment of the present invention provides a motor 100 which is a direct-circuit motor. The motor 100 includes a housing 10 with an open end, an end cap assembly 20, a stator assembly 50, a rotor assembly 60, a commutator 70, and two conducting wires 90. The end cap assembly 20 is mounted at the open end of the housing 10 to enclose the stator assembly 50, the rotor assembly 60, and the commutator 70 in the housing 10. In this embodiment, the end cap assembly 20 further acts for EMI shielding. The stator assembly 50 is fixedly mounted in the housing 10. The rotor assembly 60 is rotatably received in the stator assembly 50. The commutator 70 is fixedly mounted to the rotor assembly 60 and rotates along with the rotor assembly.

The conducting wires 90 are used to connect the motor 100 to an external power source (not shown) for supplying power to the motor 100. In this embodiment, the conducting wires 90 include a positive wire and a negative wire (not labeled) for connecting with the external power source.

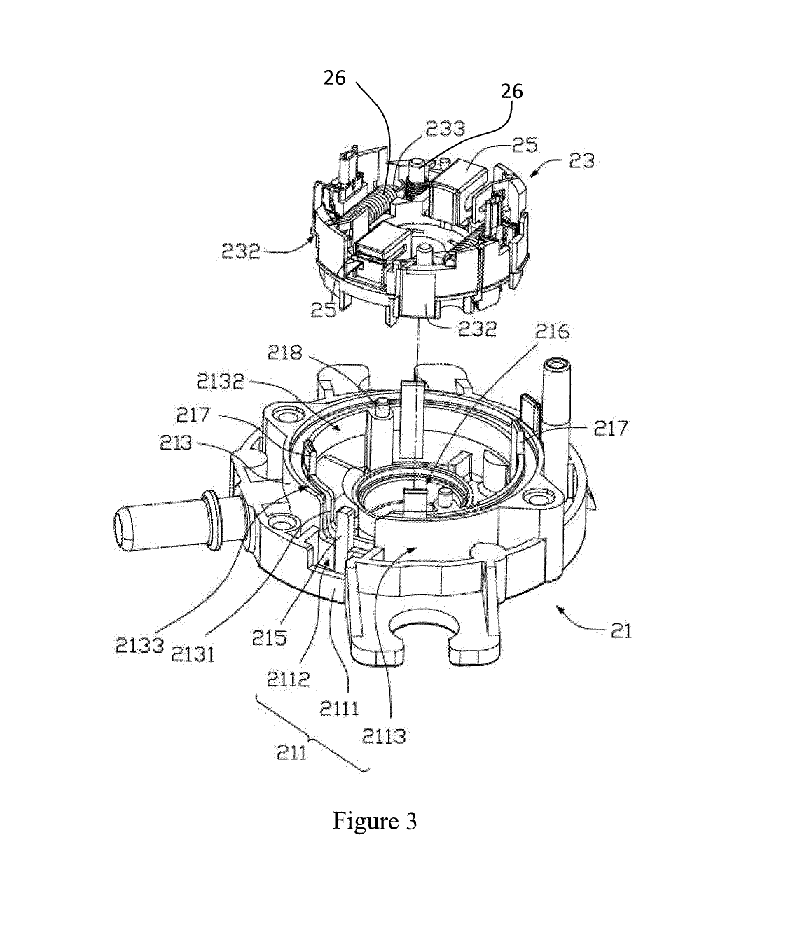

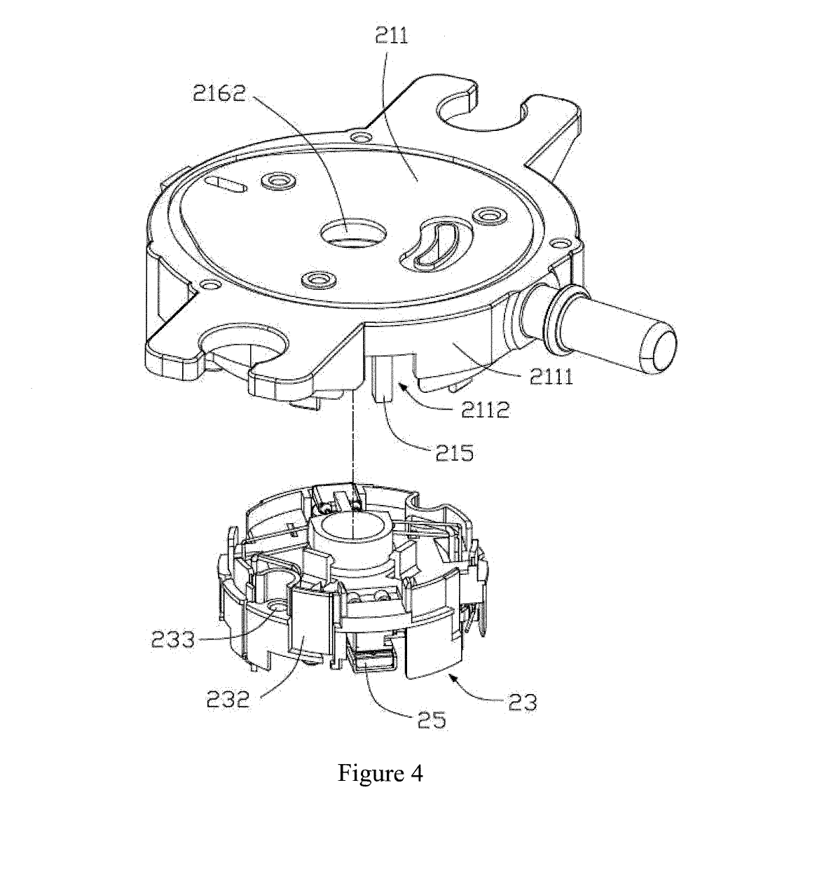

Referring to FIG. 3 and FIG. 4, the end cap assembly 20 includes an end cap 21, a mounting bracket 23, and a plurality of electrical components mounted to the mounting bracket 23. In one embodiment, the electrical components includes two brushes 25, chokes 26 and capacitors 27. Each of the brushes 25, one of the chokes 26, and one of the capacitors 27 are connected in serial for suppressing the EMI. The end cap 21 is used to support the mounting bracket 23, and thereby supporting the electrical components. Upon the end cap 21 being mounted to the end of the housing 10, the brushes 25 and the commutator 70 (see FIG. 2) are slidingly electrically connected with each other to provide an alternating current to the motor 100.

The end cap 21 includes an end wall 211, a sidewall 231 projecting from one side of the end wall 211, and a shielding member 215. In this embodiment, the sidewall 213 is generally a hollow cylinder defining an interior receiving space 2132 for receiving the electrical components. The sidewall 213 defines a cutout 2131 for allowing the conducting wires 90 to pass therethrough to connect the external power source with the brushes 25. A top end of the sidewall 213 (an end away from the end wall 211) defines an engagement groove 2133 for engaging with the mounting bracket 23. In this embodiment, the engagement groove 2133 is a generally annular, continuous groove with two ends in communication with the cutout 2131.

It should be understood that, in another embodiment of the present invention, the engagement groove 2133 may also include multiple arc grooves that are defined circumferentially at one end of the sidewall 213 and are not in communication with each other.

The end wall 211 includes fixing structures such as lugs for connecting with an external box or fixing plane (not shown). When the end wall 211 is used to connect to an external box, the box may be a protective casing 10 that is disposed around the housing 10; when the end wall 211 is used to connect to a fixing plane, the motor 100 may be fixed to a work platform for more stable operation of the motor 100.

In this embodiment, a flange 2111 extends from an outer edge of the end wall 211 in the same extending direction as the sidewall 213. The flange 2111 defines an opening 2112 aligned with the cutout 2131. In order to reduce weight and material of the end cap 21, a hollow area 2113 is formed between the flange 2111 of the end wall 211 and the sidewall 213.

The shielding member 215 is generally elongated, which projects from the end wall 211 and is located at a substantially middle of the cutout 2131 to divide the cutout 2131 into left and right portions. The shielding member 215 is used to shield the EMI generated by the motor 100 during operation. In this embodiment, an end face of one end of the shield member 215 away from the cutout 2131 is leveled with a top end face of the sidewall 213, i.e. the shielding member 215 and the sidewall 213 have the same height. The height refers to the dimension of the shielding member 215 and the sidewall 213 in a direction perpendicular to the end wall 211.

The end cap 21 further includes a bearing seat 216, a plurality of positioning portions 217, and a plurality of guide posts 218 in the receiving space 2132 defined by the sidewall 213. The bearing seat 216 defines a through hole 2162 (FIG. 4). A bearing is mounted in the bearing seat 216, for rotatably supporting a rotary shaft of the motor. The positioning portions 217 are used to position the mounting bracket 23, such that the mounting bracket 23 is mounted to the end cap 21 at a preset angle. The guide posts 218 are used to guide the mounting bracket 23 to be mounted to the end cap 21.

One end of the mounting bracket 23 is received in the engagement groove 2133. A circumferential side of the mounting bracket 23 is formed with a plurality of latch portions 232 each for latching a corresponding one of the positioning portions 217. The mounting bracket 23 defines a plurality of engagement holes 233 each receiving a corresponding one of the guide posts 218.

It should be understood that it is not intended to limit the forms of the positioning portions 217 and the latch portions 232 to those described above. Instead, the positioning portions 217 may be disposed on the mounting bracket 23, and the corresponding latching portions 232 may be disposed on the end cap 21. The guide posts 218 may be disposed on the mounting bracket 23, and the corresponding engagement holes 233 may be formed on the end cap 21.

In the preferred embodiment of the present invention, mounting and functions of the stator assembly 50, the rotor assembly 60, the commutator 70 and the brushes 25 are known in the art and, therefore, are not repeated herein. The two conducting wires 90 are electrically connected between the positive and negative electrodes of the external power source, and the brushes 25, respectively. It should be understood that, in another embodiment, the motor may also be a brushless motor, in which case, the brushes 25 mounted on the end cap 21 is replaced by a commutation controller, and the commutator is not needed. In addition, the two conducting wires 90 are electrically connected between the positive and negative electrodes of the external power source, and corresponding terminals of the commutation controller, respectively. The two conducting wires 90 pass through the cutout 2131 from left and right sides of the shielding member 215, respectively.

In use, electromagnetic waves of specific frequency, such as 1447 MHz, cause large interferences to the external devices. Therefore, in evaluating the EMI shielding performance, the performance of shielding the electromagnetic wave of this frequency is usually evaluated.

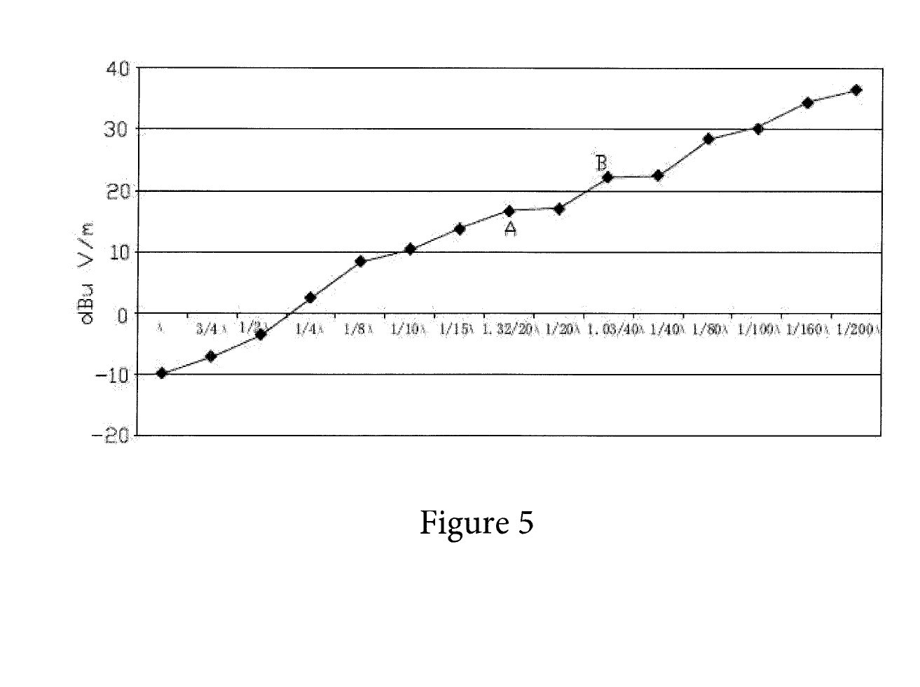

FIG. 5 shows theoretical calculations of the performance of shielding the electromagnetic wave of 1447 MHz by the motor 100 of the preferred embodiment of the present invention and a traditional motor, where point A represents the shielding performance of the traditional motor, and point B represents the shielding performance of the motor 100 of the preferred embodiment of the present invention. In this figure, the vertical axis represents the noise level, with larger values indicating greater shielding performance; the horizontal axis represents the relationship between the maximum size of a cutout and the wavelength of the electromagnetic wave, with the maximum size being the greatest one of length, width and height of the cutout.

For a member having a generally rectangular cutout, its shielding performance is calculated using the formula:

SE=100−201gL−201gf+201g(1+2.31g(L/H)),

where, L is the length of the cutout, H is the width of the cutout, and f is the frequency of the electromagnetic wave, which is 1447 MHz.

As to a traditional motor end cap with the cutout 2131 without the shielding member 215 , the length L is 13.6 mm, and the width H is 9.5 mm. the larger one of two dimensions in perpendicular directions of the notches is defined as the length L, and the shorter one is the width H.

Therefore, the theoretical value of the EMI shielding performance of the traditional motor end cap is as follows:

SE=100−20*log(13.6)−20*log(1447)+20*log(1+2.3*log(13.6/9.5))=16.78.

The end cap 21 of the present invention is provided with the shielding member 215. In this embodiment, the length of the shielding member 215 is 9.5 mm, the width is 3 mm, and the thickness is 2 mm. The thickness refers to the distance of the shielding member 215 extending along a radial direction of the sidewall 213. The shielding member 215 provided on the end cap 21 causes the cutout 2131 to be divided into left and right portions, with the sizes of each portion being as follows: L=9.5 mm, H=5.3 mm. In this case, the theoretical value of the EMI shielding performance of the end cap 21 is as follows:

SE=100−20*log(9.5)−20*log(1447)+20*log(1+2.3*log(9.5/5.3))=21.23.

As can be seen from the above comparison of the shielding performance, the EMI shielding performance of the end cap 21, in which the cutout 2131 is divided into the left and right portions, is apparently greater than the shielding performance of the traditional motor end cap.

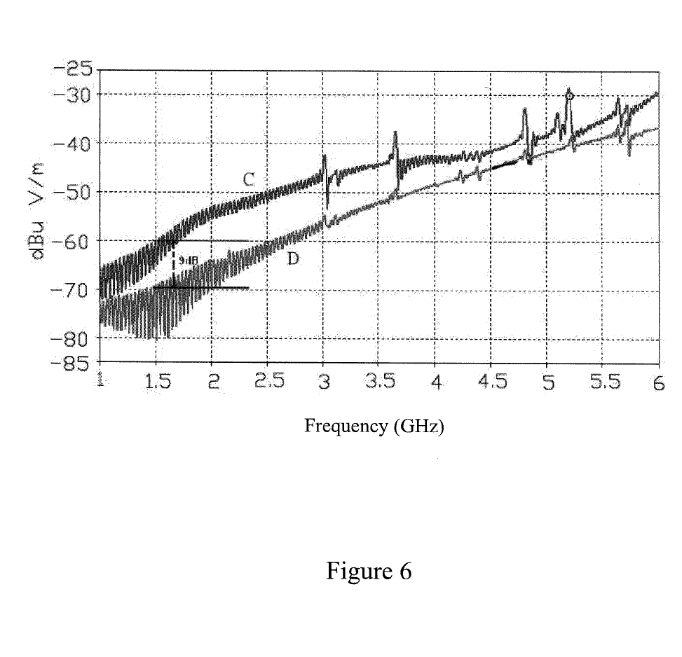

FIG. 6 shows EMI simulation results of the motor 100 of the preferred embodiment of the present invention and the traditional motor, where the horizontal axis represents the EMI frequency, with the unit thereof being GHz, and the horizontal axis represents the amplitude of the motor EMI, with the unit thereof being dBuV/m. A smaller value of the horizontal axis indicates better EMI suppressing result of the motor. In this figure, the curve C is the conductive EMI simulation curve of the traditional motor, and the curve D is the conductive EMI simulation curve of the motor 100 of the present invention. As can be seen, at the EMI frequency of 1447 MHz, the EMI intensity of the motor 100 of the present invention is about 9 dB less than that of the traditional motor.

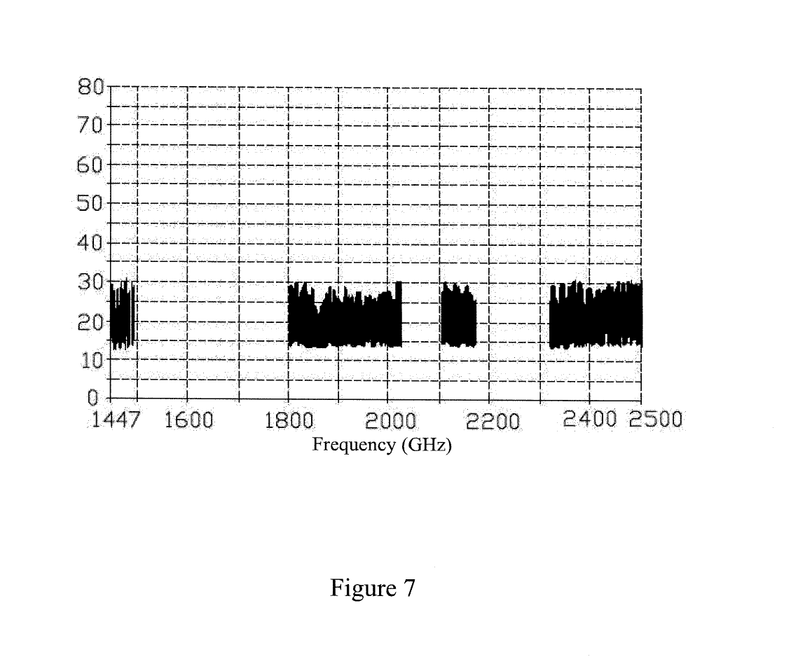

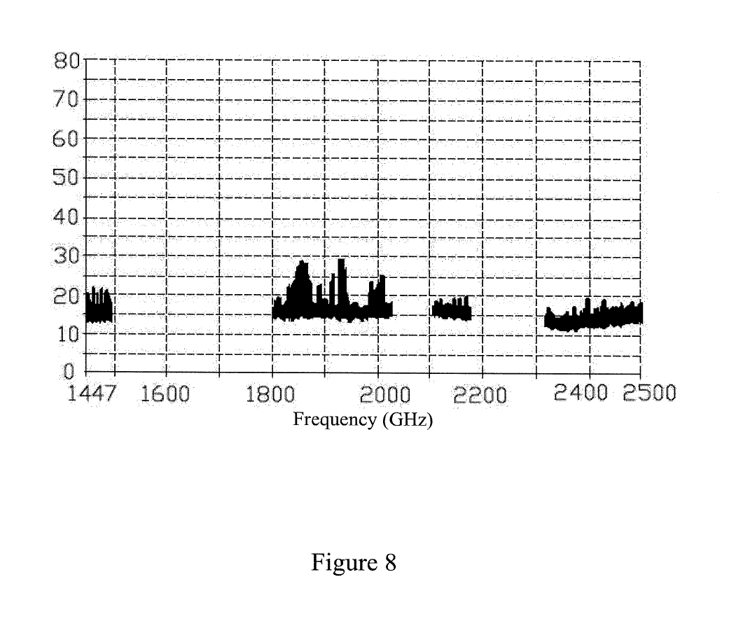

FIG. 7 and FIG. 8 show EMI test results of the motor 100 of the preferred embodiment of the present invention and the traditional motor, where the horizontal axis represents the EMI frequency, with the unit thereof being MHz, and the horizontal axis represents the amplitude of the motor EMI, with the unit thereof being dBuV/m. A smaller value of the horizontal axis indicates better EMI suppressing result of the motor. As can be seen, at the EMI frequency of 1447 MHz, the EMI intensity of the motor 100 of the present invention is about 9 dB less than that of the traditional motor, which is consistent with the simulation result.

The end cap 21 of the motor 100 is inevitably formed with the cutout 2131 as an exit of the conducting wires 90. In this invention, the shielding member 215 is disposed in the cutout 2131, which effectively enhances the EMI shielding performance of the cutout 2131 and suppresses the spread of noise. In addition, during fabrication, the shielding member can be integrally formed with the end cap 21 without increasing the cost of the end cap 21.

Although the invention is described with reference to one or more embodiments, the above description of the embodiments is used only to enable people skilled in the art to practice or use the invention. It should be appreciated by those skilled in the art that various modifications are possible without departing from the spirit or scope of the present invention. The embodiments illustrated herein should not be interpreted as limits to the present invention, and the scope of the invention is to be determined by reference to the claims that follow.

1. An end cap assembly comprising an end cap configured to supporting a plurality of electrical components, the end cap comprising:
an end wall,
a sidewall projecting from one side of the end wall to bounding a space receiving the electrical components, the sidewall defining a cutout for allowing two conducting wires to pass therethrough, the two conducting wires connecting the electrical components mounted within the end cap to an external power source; and
a shielding member disposed in the cutout.

2. The end cap assembly of claim 1, wherein the conducting wires pass through the cutout from opposite sides of the shielding member, respectively.

3. The end cap assembly of claim 1, wherein a flange extends from an outer edge of the end wall in the same extending direction as the sidewall, and the flange defines an opening aligned with the cutout.

4. The end cap assembly of claim 1, wherein the shielding member and the sidewall have the same height.

5. The end cap assembly of claim 1, wherein the end cap assembly further includes a mounting bracket, one end of the sidewall defines an engagement groove, and one end of the mounting bracket is engaged in the engagement groove.

6. The end cap assembly of claim 5, wherein the engagement groove is annular and has two ends in communication with the cutout.

7. The end cap assembly of claim 1, wherein the shielding member is elongated, which is located at a middle of the cutout to divide the cutout into left and right portions.

8. The end cap assembly of claim 4, wherein the end cap includes a positioning portion, the mounting bracket defines a latch portion, and the positioning member is latched in the latch portion;
or the mounting bracket includes a positioning portion, the end cap defines a latch portion, and the positioning portion is latched in the latch portion.

9. The end cap assembly of claim 1, wherein the end cap includes a guide post, the mounting bracket includes an engagement hole, and the guide post is received in the engagement hole;
or the mounting bracket includes a guide post, the end cap includes an engagement hole, and the guide post is received in the engagement hole.

10. A motor comprising:
a housing;
a stator assembly;
a rotor assembly;
a commutator;
two conducting wires; and
an end cap assembly mounted at one end of the housing to enclose the stator assembly, the rotor assembly, and the commutator in the housing, the end cap assembly comprising an end cap and a plurality of electrical components mounted to the end cap; the end cap comprising:
an end wall,
a sidewall projecting from one side of the end wall to bounding a space receiving the electrical components, the sidewall defining a cutout allowing the two conducting wires to pass therethrough to connect the electrical components mounted within the end cap to the external power source; and
a shielding member disposed in the cutout.

11. The motor of claim 11, wherein the conducting wires pass through the cutout from opposite sides of the shielding member, respectively.

12. The motor of claim 11, wherein a flange extends from an outer edge of the end wall in the same extending direction as the sidewall, and the flange defines an opening aligned with the cutout.

13. The motor of claim 11, wherein the shielding member and the sidewall have the same height.

14. The motor of claim 11, wherein the end cap assembly further includes a mounting bracket, one end of the sidewall defines an engagement groove, and one end of the mounting bracket is engaged in the engagement groove.

15. The motor of claim 14, wherein the engagement groove is annular and has two ends in communication with the cutout.

16. The motor of claim 11, wherein the shielding member is elongated, which is located at a middle of the cutout to divide the cutout into left and right portions.

17. The motor of claim 14, wherein the end cap includes a positioning portion, the mounting bracket defines a latch portion, and the positioning member is latched in the latch portion;
or the mounting bracket includes a positioning portion, the end cap defines a latch portion, and the positioning portion is latched in the latch portion.

18. The motor of claim 11, wherein the end cap includes a guide post, the mounting bracket includes an engagement hole, and the guide post is received in the engagement hole;
or the mounting bracket includes a guide post, the end cap includes an engagement hole, and the guide post is received in the engagement hole.
